(19) United States
(12) Patent Application Publication
(10) Pub. No.: US 2005/0241593 A1
(43) Pub. Date: Nov. 3, 2005

(54) Livestock habitat

(76) Inventor: Kamaljit S. Kaura, Laguna Hills, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/836,061

(22) Filed: Apr. 29, 2004

(51) Int. Cl. A01K 1/00

(52) U.S. Cl. 119/496

(57) ABSTRACT

An enclosure provides a portal for ingress and egress of an animal and an interior environment maintenance system including a solar electric power supply, an air cleaner, a visible light emitter, an air mover, a temperature sensor, and a control unit. The control unit is enabled for receiving an ambient temperature level signal from the temperature sensor and accordingly, switching the air mover to one of: active exhaust mode, active inlet mode and standby mode.

### INCORPORATION BY REFERENCE

Applicant(s) hereby incorporate herein by reference, any and all U.S. patents and U.S. patent applications cited or referred to in this application.

### BACKGROUND OF THE INVENTION

1. Field of the Invention

This invention relates generally to animal shelters and more particularly to an animal shelter with controlled environment.

2. Description of Related Art

The following art defines the present state of this field:

Goetz, U.S. Pat. No. Des. 334,087 describes a design for a pet carrier or similar article.

Van Buren, U.S. Pat. No. Des. 450,890 describes a design for a calf nursery.

Parker, U.S. Pat. No. 823,544 describes a hutch having a fixed stud on each side and a long lever mounted near one end on each stud, a roller and roller axis carried by each lever at one end, and the opposite end of each lever is formed as a handle, and guides fixed to the hutch through which the handle ends of the levers pass.

Patterson, U.S. Pat. No. 3,785,344 describes a cage apparatus for confining an animal within a cage and preventing undesired movement of the cage including an animal cage having wheels mounted at the rear thereof, resilient support means mounted at the front of the cage to support the cage and to provide reaction forces in substantially the opposite direction from forces exerted by the animal in the cage such that the cage tends to move in substantially one direction only; and, transport means for connecting to the front end of the cage to render the cage transportable.

Tellers, U.S. Pat. No. 4,292,929 describes an incubator particularly useful for calves and the like comprising a wheel supported generally box-like structure with a door to permit placement of the calf into, and removal of the calf from, the incubator, a heat source in the top wall, an opening in the front wall for feeding and a pail support assembly proximate the opening.

Allen, Jr., U.S. Pat. No. 5,316,977 describes a mobile, insulated, and compartmented animal shelter having a living compartment and an overhead loft. The loft is provided with an electric heating system mounted on a pallet that may be slid into and out of the loft through a hinged access door. An air duct conveys warm air from the heater through outlets in the duct, pallet and ceiling panel and into the living compartment.

Goetz, U.S. Pat. No. 5,220,885 describes a portable litter box for a cat or other domesticated animal comprising a housing having upper and lower sections detachably securable to provide a substantially closed container. The sections are stackable or nestable for storage, shipping and/or display. Preferably, the upper section includes an opening for ingress and egress to the housing and a carrying handle for the box as well as means for holding a freshener; the lower section may include skid resistant feet. Pins are provided for detachably securing the sections together in assembly.

Ho, U.S. Pat. No. 5,467,734 describes an animal house including a number of elements that can be easily assembled and disassembled, the elements can be arranged in a compact configuration and can be packaged in a small box such that the animal house having a configuration that is good for transportation purposes. The animal house includes four wheels disposed in the bottom portion for facilitating movement of the animal house. Four stops are slidably engaged in the animal house for engaging with the wheels so as to limit rotational movement of the wheels.

Markey et al., U.S. Pat. No. 5,551,371 describes a pet enclosure having a generally hollow box-shaped base and a roof, which is hingedly attached to the base. The hinged roof allows simplified access to the interior of the pet enclosure for cleaning, whelping or the like. The roof of the pet enclosure includes a chimney within which is located a passive vent which can be opened or closed to allow airflow through the pet enclosure to be controlled. A further embodiment of the pet enclosure includes an optional plastic curtain door and/or a solar powered vent fan, which replaces the passive vent.

Fields, U.S. Pat. No. 6,176,201 describes a ventilated cat litter box for ventilating cat litter and simultaneously keeping the surrounding area litter free. The ventilated cat litter box includes a box, which is generally rectangular in shape. The box has a top portion, a bottom portion, a middle portion, a first wall, a second wall, a third wall, and a fourth wall. A screen covers the bottom portion of the box and is parallel to the bottom portion. A container, rectangular in shape, is located within the box upon the screen. An arched doorway is located in the first wall. A rectangular cavity is located in the top portion of the box. An electric fan is mounted in the inside of the box and is adjacent to the cavity. An actuating device is operationally coupled to the electric fan. A power source is operatively coupled to the actuating device. A ventilation port is attached to the cavity whereby the port extends upwardly away from the box. An exhaust tube has a first end and a second end. The first end is removably connected to the ventilation port.

Busch, U.S. Pat. No. 6,295,765 describes a movable shelter for providing a shelter for animals that would be dry and warm. The movable shelter includes a base member including a first sprocket adapted to be rotatably mounted upon a ground such as a cement slab and also including a shaft securely mounted to the first sprocket for rotation therewith and being adapted to be generally perpendicular to the ground; and also includes a building structure having a floor, side walls, front wall, back wall, a roof, and an opening in the front wall with the building structure being securely mounted upon the shaft for rotation therewith; and further includes a rotation assembly for rotating the building structure.

Bogner et al., U.S. Pat. No. 6,425,347 describes a portable livestock-incubating device that is formed of a rectangular container having and incubating volume forming an incubating chamber defined by the zone within the incubating volume. Each end wall further includes an access door hingedly attached to an upper portion above a clean out door for providing ingress and egress of livestock. Each access door has an exhaust vent located at an upper portion whereby heated air, generated via an electric heater within said the incubating chamber exhausts therethrough. A base with wheels mounted thereon for facilitating transportation of the portable livestock-incubating device.

Branham, U.S. 2004/0005251 describes an apparatus that disinfects room air by destroying common allergens such as mold spore, dust mites, microbes, and VOCs, as well as dangerous substances, both organic and inorganic. Using photocatalytic oxidation, it places a continuing supply of the oxygen radical hydroxyl into a local environment. This helps prevent the spread of infectious diseases by destroying infectious microbes, contained in the droplet nuclei of human and animal respiration, as they float in the air. This apparatus also removes carbon monoxide, radon and other contaminants from the air by turning them into such harmless substances as carbon dioxide and water. It uses little energy, needs no filters, and operates silently.

Our prior art search with abstracts described above teaches: a design for a pet carrier, a design for a calf nursery, a means for transporting rabbit or poultry hutches, a cage apparatus, a calf incubator, an animal shelter, a litter box, a movable animal house, a pet enclosure, a ventilated cat litter box, a movable shelter, a livestock incubator, and an allergy lamp, but does not teach INSERT. The present invention fulfills these needs and provides further related advantages as described in the following summary.

### SUMMARY OF THE INVENTION

The present invention teaches certain benefits in construction and use which give rise to the objectives described below.

The present invention relates to a calf or other animal incubator enclosure and includes improved means for feeding the calf while housed within the incubator. The enclosure may be used for newborn animals as an incubator, to nurse sick animals, and for quarantine and other similar purposes. The general objective when used as an incubator is to provide a draft-free, germ-free, controlled environment for the calf or other animal from the time of birth until it is strong enough to fend for itself. The particular length of time the calf is kept in the incubator will depend upon the condition of the calf; however, generally calves are kept in the incubator from time of birth until approximately seven days old. Results from using the incubator of the present invention have shown that calves which are kept warm and dry in the incubator atmosphere have a much improved chance of survival through the early critical days. Further, the incubator provides the calf with a much better and healthier start in life than calves not placed in the incubator. The present invention, a true livestock habitat, includes a novel design configuration producing a product that has advantages in its fabrication and use. The result provides a unique capability for the growth of animals by providing a healthy environment and protecting the animal from extremes in temperature, humidity and pathogen load. Animal comfort and health is improved over conventional animal incubators and shelter designs and operations, and this leads to less sickness, lower morbidity, and faster animal growth.

The important design aspects of the present enclosure invention include a roof designed to channel rainwater away from the structure thereby improving the external environment. Permanent wheels are placed in such a manner that when the structure is tilted to one side, it is easily moved by one person over short distances without the use of moving equipment. When the shelter is righted, the wheels are lifted out of contact with the ground. The shelter's frame incorporates slots for insertion of a forklift to raise and move the structure. Two lifting hooks are provided for moving the structure. Molded channels at the top of the structure enable manual lifting for cleaning, etc. The structure provides attachment points for an external fence for providing an outdoor pen allowing caged movement of an animal outside of the enclosure. Surfaces of the structure have mirror-finishes to avoid microbe formation. Vents are positioned in a manner to maximize air flow for interior temperature control. A door with a ventilation panel is able to fully close the interior of the structure for application to extreme cold conditions. The exterior finish is designed to reject heat load or losses depending on the local environment and weather. Exterior surfaces of the structure are angled and positioned to disperse heat more efficiently so as to eliminate heat concentrations.

A UV lamp and a fan are powered by a photovoltaic solar energy system having storage battery and external power hookup. The fan is reversible so as to move air through the shelter in two modes depending on temperature sensors located within and external to the shelter. The fan works in conjunction with the UV lamp to assure a uniform effect on airborne pathogen vectors. A fluorescent light is provided to assure a natural environment within the structure to maximize the growth of an animal. A heat pump, driven by the solar energy system, is employed for both heating and cooling of the structure. The heat pump employs no moving parts but provides a radiator directly in line with the fan for efficient heat flow.

A rectangular cavity in one wall of the structure is sized to receive a bottle with a feeding nipple for liquids. The cavity is positioned at an angle to avoid animal neck stress during feeding. This same wall facilitates the placement of feeding containers of various sizes for solid and liquid animal feed. Floor angle and side gutters provide a means for eliminating liquids within the shelter.

A primary objective of the present invention is to provide an apparatus and method of use of such apparatus that yields advantages not taught by the prior art.

Another objective is to provide such an invention capable of providing an ideal environment for a farm or other animal during the early critical days after birth.

A further objective is to provide such an invention capable of automated temperature control within an animal enclosure.

A still further objective is to provide such an invention capable of minimizing pathogen populations within the animal enclosure.

A yet further objective is to provide such an invention capable of being manufactured at low cost and in high volume.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a frontal perspective view of the invention, an animal enclosure, showing a front door, side mounted wheels and tube carry mounts on top;

FIG. 2 is a further frontal perspective view thereof showing front door removed, corral pen attached and eye bolts mounted on top for lifting;

FIG. 3 is a rear perspective view thereof showing feeding ports on a back wall;

FIG. 4 is a cutaway view of the interior thereof as viewed from the front and showing the feeding ports;

FIG. 5 is an elevational view thereof showing a method of moving the invention on built-in wheels;

FIG. 6 is a mechanical schematic of the environmental maintenance system thereof showing its elements and relationship to a control unit; and

FIG. 7 is an electrical block diagram of the environment control system thereof.

### DETAILED DESCRIPTION OF THE INVENTION

The above described drawing figures illustrate the invention in at least one of its preferred embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

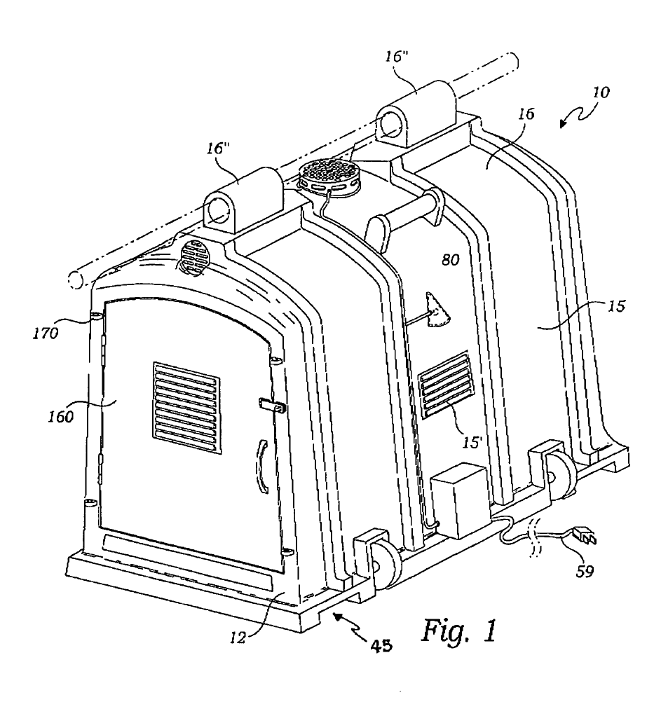

The present invention is an animal shelter apparatus formed as an enclosure 10 of molded plastic construction, as shown in FIG. 1. Typically, the enclosure 10 is about 54″ in height, 87″ in length (front to back) and 48″ in width (side to side); and weighs about 75 pounds. The enclosure 10 is enabled, as will be described below, for housing, feeding and exposing a young farm animal to controlled and clean environment. The enclosure 10 includes an integral formation of a front wall 12, a back wall 13, a left side wall 14, a right side wall 15, a roof 16 and a floor 17 as shown in the figures and as is well known in the art. The interior surfaces of these walls, roof and floor are finished with a smooth surface to avoid the harboring of microorganisms. The sides 14, 15 are sloped for improved runoff of rain water and absorption of solar heat through the sides of the enclosure. The front wall 12 provides a portal 12′ for ingress and egress of an animal such as a calf, kid, foal, or other young farm stock animal, and the enclosure 10 is particularly sized and enabled for supporting such an animal.

Of particular importance in the present invention is an interior environment maintenance system 20 enabled for assuring a clean and healthy environment for the animal occupant. This maintenance system 20, shown in one embodiment schematically in FIG. 6, preferably includes an electric power supply 30 and may include a 12-14 VDC regulated power supply supplied as part DHK50097 by DHK Defense & Aerospace of Laguna Hills, Calif., a photovoltaic power panel DHK50093, a nickel cadmium or nickel metal hydride type battery DHK50096-RPS-1, and components: an air cleaner such as an ultraviolet energy emitter 40 such as DHK700089-UVL-1, and, or an air ionizer 40′ such as DHK700093-IMA-1, a visible light emitter 60 such as DHK50091-CFL5-1, an air mover 70 or fan assembly DHK50092-FA4-1, a temperature sensor 80 such as any commercially available thermometer unit having at least two points of temperature sensing for interior temperature and exterior temperature, a heat transfer device 90, such as heat pump DHK50094, and a control unit 100. The control unit 100, preferably a solid state programmable controller such as any common industrial controller commercially available from General Electric Company, Honeywell Corp. and others, or DHK50095, and which is well known to those of skill in the art, is enabled by programming an internal software program. Ambient temperature levels of both interior air and outside air provide signals TS1 and TS2, from the temperature sensor 80, and in accordance with the programmed instructions in the control unit 100, provide switching of the air mover 70 to one of: active exhaust mode (AEM), active inlet mode (AIM) and standby mode, and also switching of the heat transfer device 90 to one of: heat absorbing mode (HAM), heat emitting mode (HEM), and standby mode.

The apparatus has ample air vents, and in particular wall vents 15′ and a roof vent 16′, which enable air flow into and out of the interior 5 of the enclosure 10. With the air mover in active exhaust mode (AEM), impellor rotation is such as to move air out of the interior 5, particularly through the roof vent 16′. Makeup air moves through wall vents 15′ into the interior 5. Programming of the control unit 100, for example, may call for active exhaust mode when the interior starts to exceed a maximum selected interior temperature. This may be expressed as: AEM when Ti=>90 F. Where Ti represents the interior temperature. Generally, cooler outside air settles near ground level and it therefore becomes beneficial to draw such air into the interior by starting AEM. When Ti moves below the selected temperature the air mover 70 may then be switched off.

With the air mover in active inlet mode (AIM), impellor rotation is such (reversed) as to move outside air into the interior, again, via the roof vent 16′ with interior air moving out of the enclosure 10 through the wall vents 15′. This mode is efficient in replacement of chilled and wet interior air with warmer dry outside air especially in the early morning when the outside air warms-up rapidly after sunrise while inside night air might very well otherwise remain chilled for most of the day. Standby mode for the air mover switches off power so that no forced air movement occurs.

When the apparatus is used in climates with extreme temperatures, the heat transfer device 90 my be employed to maintain interior temperatures at satisfactory levels. With the heat transfer device 90, preferably a heat pump of any type well known in the art, switched to heat absorbing mode, i.e., chilling, air within the interior may be cooled by placing the air mover 70 in AIM so that outside air drawn through roof vent 16′ passes over cooling coils the heat transfer device 90 and enters the enclosure 10 moving downwardly to cool the interior 5. With the heat transfer device 90 switched to heat emitting mode, the air in the interior may be heated in the same manner. With the heat transfer device 90 switched to standby mode, electric current is switched off.

The control unit is further enabled for adjusting the illumination level within the interior 5 by controlling power to the visible light emitter 60, preferably one or more fluorescent lamps, generally in accordance with a preset time schedule as determined by a clock signal from the solid state programmable controller (control unit 100). Thus, full interior illumination may be provided during daylight hours while interior lighting may be automatically extinguished during night or sleeping hours. When the light emitter 60 is able to be dimmed, the programmable controller or control unit 100 may be set to adjust the illumination level in the interior 5, as desired and automatically from time to time.

The control unit 100 is further enabled for adjusting one or more on-off cycles of the ultraviolet energy emitter 40, and, or the air ionizer 40′, in accordance with preset time schedules as determined by the clock signal. Destruction of air borne bacteria via ultraviolet energy, or ionized air exposure is well known in the art and the cycles of such exposure are automatically controlled by the control unit.

The electric power supply 30 preferably includes a solar energy electric converter 50 exposed to solar radiation by its placement on the exterior of the roof 16 as shown in FIGS. 1-3. Received solar energy at the solar energy electric converter 50, for instance, photovoltaic cells, is conducted to a storage battery 55 for present or later use. Electric utility needs in the apparatus my be fulfilled from the storage battery 55 assuming that all needs are compatibly operated on low voltage DC current. Alternately, an inverter 58 may be employed to provide AC current which may be voltage adjusted using a step-up transformer as required. When convenient, power grid utility supplied AC current may be employed in place of, or as a compliment to, the solar energy system described. Therefore, a utility power inlet cable 59, and an AC operated battery charger 57 are preferably part of the electric power supply of the invention.

Preferably, the back wall 13 includes a feeding flap 110 and adjacent thereto, a feed trough mount 120 with a feeding trough 120′ in place for receiving solid foods for the animal occupant. The back wall 13 further includes a feed-bottle chute-rest 130 as shown. Stock may be fed liquids from a feed bottle 130′ place into and resting within the chute-rest 130.

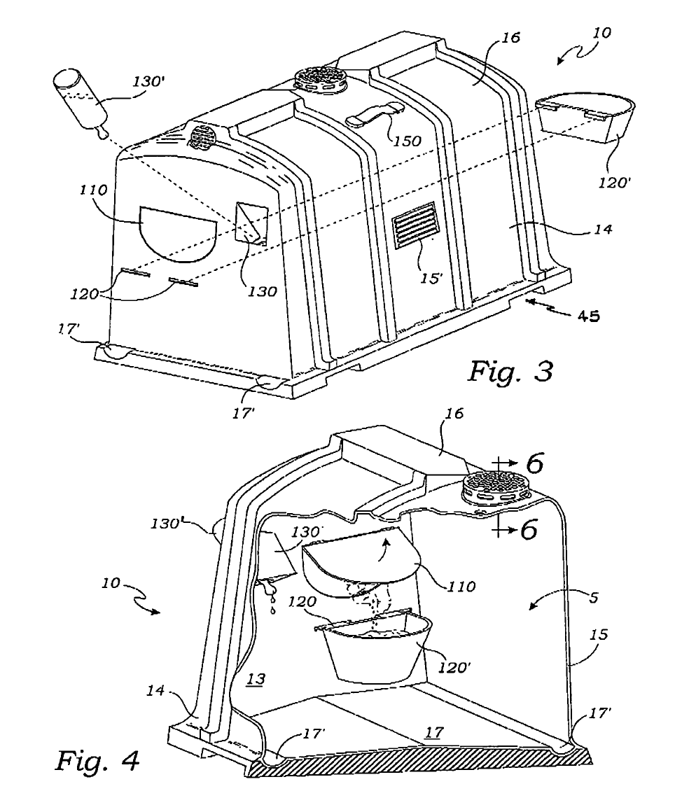

Preferably, the floor 17 includes a slope of a few degrees for diverting liquid runoff, and at least one gutter 17′ for receiving the liquid runoff and conducting it to the exterior. This is shown in FIGS. 4 and 3 respectively.

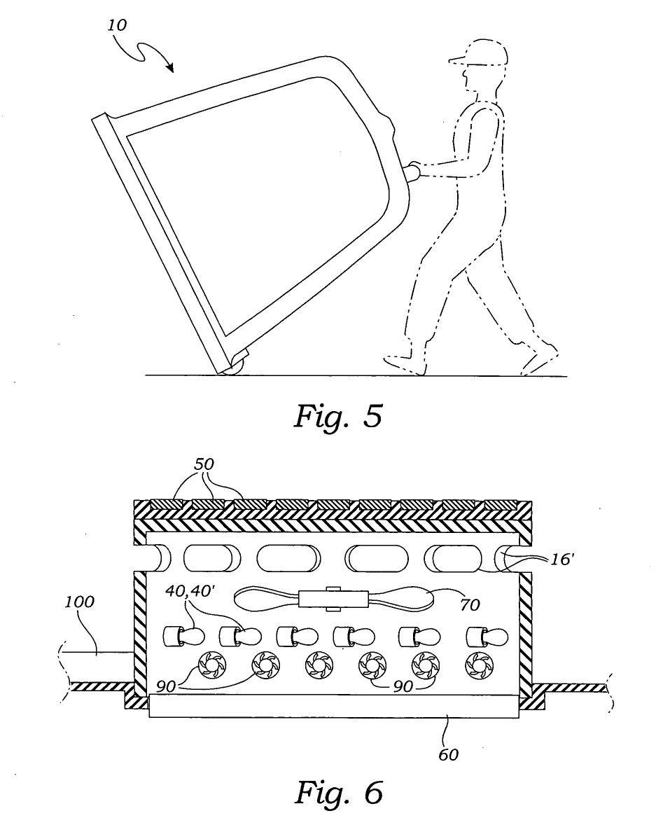

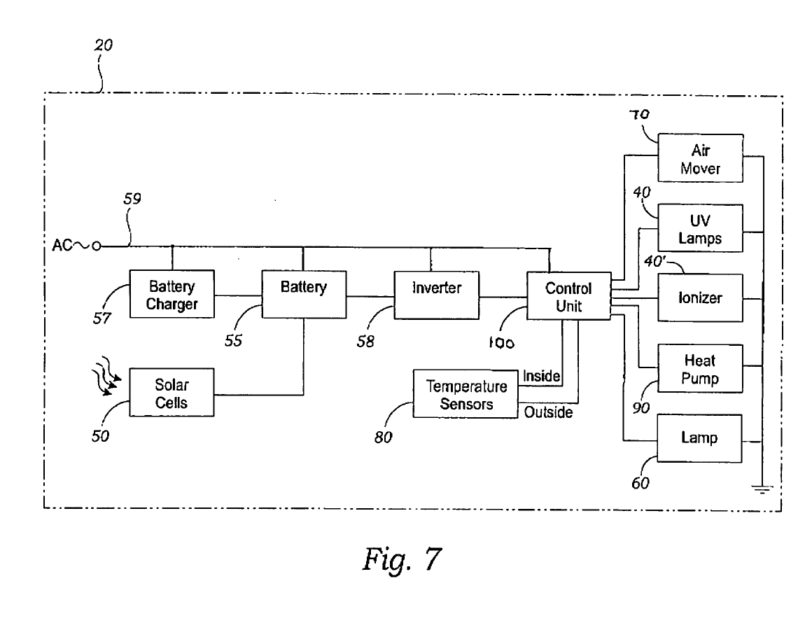

Preferably, one of the side walls includes plural wheels 140 positioned above the ground surface upon which the apparatus rests. The wheels 140 are positionable in contact with the ground surface by manually tilting the apparatus toward the wheels 140, as shown in FIG. 5. A handle 150 is provided for manually pulling or pushing the apparatus on the wheels 140. When the apparatus is repositioned, it is set back into its upright attitude, again, by manually tilting, so that it rests fully on its floor 17 and the wheels 140 are then, again, not in contact with the ground surface. The apparatus may be moved also by a fork lift truck as slots 45, a means for receiving the forks of such a lift truck, are incorporated into the floor 17 of the enclosure 10, and this is clearly shown in FIGS. 1-3.

Preferably, the front wall provides a hinged door 160 which may be opened or closed, and also, a means for corral attachment 170, whereby, a corral fence 180 which is enabled for removable engagement with the corral attachment 170 establishes a pen exterior to the front wall 12 and adjacent thereto. With the pen in place, the animal occupant is able to move out of the enclosure 5 while being yet restrained.

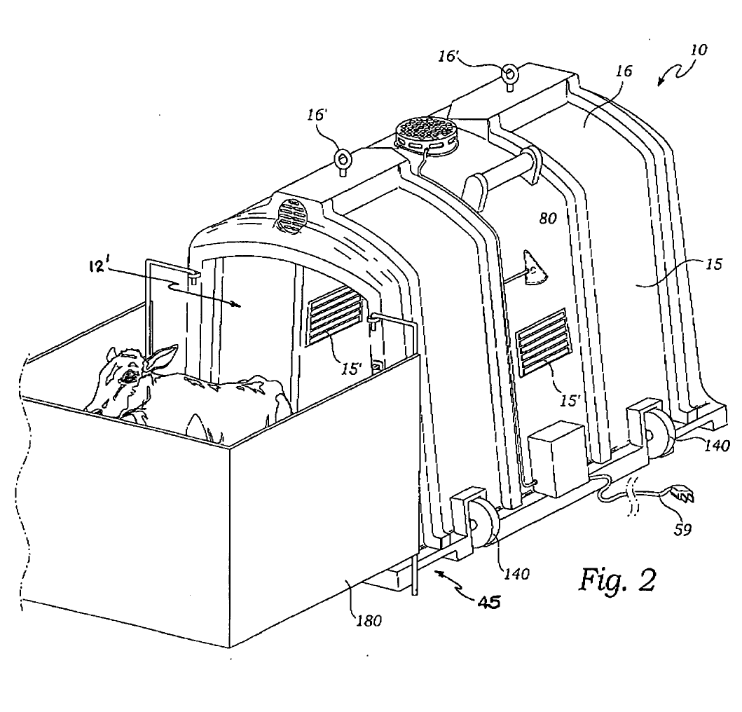

Preferably, the roof 16 provides a means for attachment 16″ for lifting the apparatus, as shown in FIG. 1 as lifting tubes, or in FIG. 2 as eye bolts. As shown in FIG. 1, the lifting tubes may be engaged by long rods or beams to enable two individuals to lift or move the apparatus over short distances.

The enablements described in detail above are considered novel over the prior art of record and are considered critical to the operation of the instant invention and to the achievement of the above described objectives. The words used in this specification to describe the invention and its various embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of this described invention and its various embodiments are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

1. An animal shelter apparatus comprising: an enclosure including integrally, a front wall, a back wall, a left side wall, a right side wall, a roof and a floor; the front wall providing a portal for ingress and coress of an animal; a side wall providing wheels positioned therewithin for moving the apparatus upon tilting the apparatus to one side; an interior environment maintenance system including an electric power supply, at least one of an ultraviolet energy emitter and an air ionizer, a visible light emitter, an air mover, a temperature sensor, a heat transfer device and a control unit; the control unit enabled for receiving an ambient temperature level signal from the temperature sensor and accordingly:
a) switching the air mover to one of: active exhaust mode, active inlet mode and standby mode,
b) switching the heat transfer device to one of: heat absorbing mode, heat emitting mode, and standby mode.

2. The apparatus of claim 1 wherein the control unit is further enabled for adjusting an illumination level of the visible light emitter, in accordance with a preset time schedule as determined by a clock signal.

3. The apparatus of claim 1 wherein the control unit is further enabled for adjusting an on-off cycle of the ultraviolet energy emitter, in accordance with the preset time schedule as determined by the clock signal.

4. The apparatus of claim 1 wherein the control unit is further enabled for adjusting an on-off cycle of the air ionizer, in accordance with the preset time schedule as determined by the clock signal.

5. The apparatus of claim 1 wherein the electric power supply includes a solar energy electric converter and a storage battery.

6. The apparatus of claim 5 wherein the electric power supply further includes a utility power inlet cable, an inverter, and a battery charger.

7. The apparatus of claim 1 wherein the back wall includes a feeding flap and adjacent thereto, a feed trough mount.

8. The apparatus of claim 1 wherein the back wall includes a feed-bottle chute-rest.

9. The apparatus of claim 1 wherein the floor includes a slope for diverting liquid runoff and at least one gutter for receiving the liquid runoff.

10. (canceled)

11. The apparatus of claim 1 wherein the front wall provides means for corral attachment.

12. The apparatus of claim 11 further comprising a corral fence enabled for removable engagement with the corral attachment for establishing a pen exterior to the front wall and adjacent thereto.

13. An animal shelter apparatus comprising: an enclosure providing a portal for ingress and egress of an animal; an interior environment maintenance system including an electric power supply, an air cleaner, a visible light emitter, an air mover, a temperature sensor, and a control unit; the control unit enabled for receiving an ambient temperature level signal from the temperature sensor and accordingly, switching the air mover to one of: active exhaust mode, active inlet mode and standby mode; a wall of the enclosure providing wheels positioned therewithin for moving the apparatus upon tipping the apparatus to one side.

14. The apparatus of claim 13 further comprising a heat transfer device engaged with the control unit for switching the heat transfer device to one of: heat absorbing mode, heat emitting mode, and standby mode.

15. The apparatus of claim 13 wherein the control unit is further enabled for adjusting an illumination level of the visible light emitter, in accordance with a preset time schedule as determined by a clock signal.

16. The apparatus of claim 13 wherein the control unit is further enabled for adjusting an on-off cycle of an ultraviolet energy emitter, in accordance with the preset time schedule as determined by the clock signal.

17. The apparatus of claim 13 wherein the control unit is further enabled for adjusting an on-off cycle of the air ionizer, in accordance with the preset time schedule as determined by the clock signal.

18. The apparatus of claim 13 wherein the electric power supply includes a solar energy electric converter and a storage battery.

19. The apparatus of claim 18 wherein the electric power supply further includes a utility power inlet cable, an inverter, and a battery charger.

20. The apparatus of claim 13 wherein the back wall includes a feeding flap and adjacent thereto, a feed trough mount.

21. The apparatus of claim 13 wherein the back wall includes a feed-bottle chute-rest.

22. The apparatus of claim 13 wherein the floor includes a slope for diverting liquid runoff and at least one gutter for receiving the liquid runoff.

23. (canceled)

24. The apparatus of claim 13 wherein the enclosure provides means for corral attachment.

25. The apparatus of claim 24 further comprising a corral fence enabled for removable engagement with the corral attachment for establishing a pen exterior to the front wall and adjacent thereto.

26. The apparatus of claim 13 further comprising a means for accepting forks of a lift truck for lifting the apparatus and for moving the apparatus.

27. The apparatus of claim 13 wherein the roof provides a means for attachment for lifting the apparatus, the attachment means comprising a pair of spaced apart lifting tubes capable of receiving a pole for lifting the apparatus.

28. The apparatus of claim 13 wherein the control unit controls the air cleaner, the visible light emitter, the air mover, the temperature sensor, a heat pump, an ionizer, and a UV lamp for controlling the environment within the apparatus.
